(19) United States
(12) Patent Application Publication
(10) Pub. No.: US 2008/0276809 A1
(43) Pub. Date: Nov. 13, 2008

(54) Roasting Device

(76) Inventor: Angela King, Pulham St. Mary (GB)

Correspondence Address: DEFILLO & ASSOCIATES, INC., P.O. Box 14104, Clearwater, FL, 33766, US

(21) Appl. No.: 11/791,575

(22) PCT Filed: Oct. 27, 2005
(86) PCT No.: PCT/GB05/04188

§ 371 Date: Mar. 31, 2008

(30) Foreign Application Priority Data
Nov. 24, 2004 (GB) 0425812.5
May 25, 2005 (GB) 0510636.4

(51) Int. Cl. A47J 37/06

(52) U.S. Cl. 99/377

(57) ABSTRACT

A roasting device (11) suitable for roasting meat comprising a rotatable spit (18) on which, in use, the meat is located and in which the primary heating effect is supplied by two or more heating units (12) located respectively on opposite sides of the spit adjacent the longitudinal axis of the spit.

### CROSS REFERENCE

This application is a national stage of PCT/GB2005/004188 filed Oct. 27, 2005 and is based upon GB Patent Applications No. GB 0425812.5 filed Nov. 24, 2004 and No. GB 0510636.4 filed May 25, 2005 under the International Convention.

### FIELD OF THE INVENTION

The invention relates to roasting devices and especially to roasting devices suitable for use outdoors.

### DESCRIPTION OF THE PRIOR ART

Review of the Art known to the Applicant In recent times there has been an increase in the number of outdoor parties, such parties commonly involving barbecues and more recently, events where an entire pig is roasted, the roasting of such pigs being common at organized events designed to raise money for charities. There are two common methods in which pigs are roasted at such events. The first of these methods involves positioning the pig on a spit which is then rotated above an open fire. This method of cooking a whole pig has associated with it the inherent dangers of having a large open fire. Additionally, this method of cooking also has problems associated with it in that the fat and other juices produced during the cooking process fall from the pig and into the fire which results in flames leaping up from the fire, which can potentially cause the pig to burn at certain points. Also burning embers can be ejected from the fire as a result of such Liquids falling onto the fire and so there is a risk to persons close to the fire when such embers are ejected.

A method of cooking which has therefore been developed more recently for cooking whole pigs is that the pig is placed in a large metallic box which incorporates a loose fitting lid and the box is then heated from below by a series of gas burners. This is a much safer method of cooking a whole pig but unfortunately the quality of the thus cooked meat is not as high as that produced by the previously described method. The reason for this being that the juices which are produced during the cooking process fall from the pig onto the lower surface of the metallic box, wherein water contained in the juice is vaporized to form steam which eventually Leaks from the box along the join between the box and the lid of the box. The pig in the box is therefore part roasted by the heat from the gas burners and part steamed by the steam generated from the juices released during the cooking process.

A requirement therefore exists for a pig roasting system which has improved safety over the use of an open fire but does not have the drawbacks associated with the cooking method utilizing the metallic box described above. Such a system is described herein.

### SUMMARY OF THE INVENTION

A roasting device suitable for roasting meat comprising a rotatable spit on which, in use, the meat is located and in which the primary heating effect is supplied by two or more heating units located respectively on opposite sides of the spit adjacent the longitudinal axis of the spit. Locating the primary heating units on both sides of the meat in this way as opposed to the primary heating being on just one side, means that the cooking time for the meat can be reduced.

Additionally, the risk, due to people falling onto heater units located in such a way is significantly reduced when compared to the situation where a fire is located below the whole carcass of a pig.

Preferably the heating units are provided with adjustment means such that the proximity of each of the units is independently adjustable relative to the position of the spit. In this way multiple units supplied on either side of the meat or animal carcass to be cooked can be individually adjusted to ensure that the meat cooks evenly along the length of an animal carcass.

Preferably detachable handles are provided which can be attached and detached to the heating units on the side of the units facing away from the spit and the handles are provided with heat deflection means. The provision of detachable handles means that the handles do not heat up as they would if they remained attached to the device during the use of the device. Additionally the inclusion of heat shields provides added safety and comfort to an operator with respect to the heat emitted by the heater units.

Preferably adjustment means is provided to allow the position of all the heating units to be simultaneously adjusted. The use of a mechanism of this type improves the overall—to safety of the device as the heating level provided by multiple heating units can be remotely adjusted without an operator having to adjust the individual units, which has a risk associated with it of the operator suffering burns from the heater units. Also, the heating units can be rapidly moved away from the roasting animal, as a single unit, to allow meat to be carved from the carcass or to check whether the meat is cooked.

Preferably heater units are charcoal burning units and the heat provided by the units along the axis of the Units parallel to the longitudinal axis of the spit can be varied by varying the height of the charcoal contained within the units along said axis of the units.

The use of a mechanism of this type improves the overall safety of the device as the heating level provided by multiple heating units can be remotely adjusted without an operator having to adjust the individual units which has a risk associated with it of the operator suffering burns from the heater units.

In a particularly advantageous embodiment, an external face of one or more heater units has a curved preferably convex—e.g. domed-form. Where the heater unit is made of metal or some other material that expands significantly on heating, the provision of an initially curved or convex face enables such expansion to be accommodated without buckling of the face. With initially flat faces on heater units, the expansion that results from heating can cause the faces to buckle, Apart from being unsightly, the buckling can result in sudden changes in shape of the heater units, as the buckling stresses are released, and cause ejection of e.g. hot charcoal or embers from the heater. The unrelieved buckling stresses can also lead to premature failure of joints in the assembly.

Preferably sheltering means is provided to protect the roasting meat from rain. The provision of a sheltering means in this way means that the device can still be used outdoors even when inclement weather threatens, such that brief showers will not deleteriously affect the cooking of the meat.

Preferably the device incorporated a rack extending between the heating units, on which food can be cooked. Devices normally used to cook large pieces of meat such as pig carcasses cannot readily be used to cook smaller pieces of meat such as sausages, chops and steaks or to cook jacket potatoes and alike. The provision of a rack as described above enables a user to use the apparatus as a traditional barbecue.

Preferably the positioning of the rack allows the device to be used to cook food on the rack and simultaneously as a spit for roasting meat. In this way the spit can be used to roast whole pigs as previously described or to roast smaller items such as chickens and joints of meat while the rack is used at the same time to cook yet smaller items such as chops, sausages and steaks and to cook jacket potatoes and alike.

A roasting device suitable for roasting meat substantially as described herein with reference to and as illustrated by any appropriate combination of the accompanying drawings.

### BRIEF DESCRIPTION OF THE DRAWINGS

One presently preferred embodiment of the device will now be described by reference to the accompanying drawings in which:

FIG. 1 is a schematic perspective view of a device suitable for roasting meat embodying the invention.

FIG. 2 is a schematic plan view of a device suitable for roasting meat embodying the invention.

FIG. 3 is a schematic perspective view of a device suitable for roasting meat embodying the invention.

FIG. 4 is a schematic perspective view of the face of a heater element which is directed towards a spit of the invention in use.

FIG. 5a is a schematic perspective view of the face of a heater showing the positioning of attachment points.

FIG. 5b is an exploded view of the attachment means comprising part of the heater attachment point.

FIG. 5c is a schematic perspective view of a handle suitable for adjusting the heater elements of the device which attaches to the attachment points of the heater unit.

FIG. 5d is a schematic perspective view of a handle incorporating a heat shield suitable for adjusting the heater elements of the device.

FIG. 6 is a schematic side view showing the various positions in which panels for a shelter for the invention can be located.

FIG. 7 is a schematic perspective view showing the location of a wire mesh on the heater units of the invention.

FIG. 8 is a schematic plan view showing a heat unit support frame for the invention.

FIG. 9 is a schematic cross-section of a flat-faced heater unit before (a) and after (b) heating.

FIG. 10 is a schematic cross-section of a curved-faced heater unit before (a) and after (b) heating.

### DESCRIPTION OF THE PREFERRED EMBODIMENT

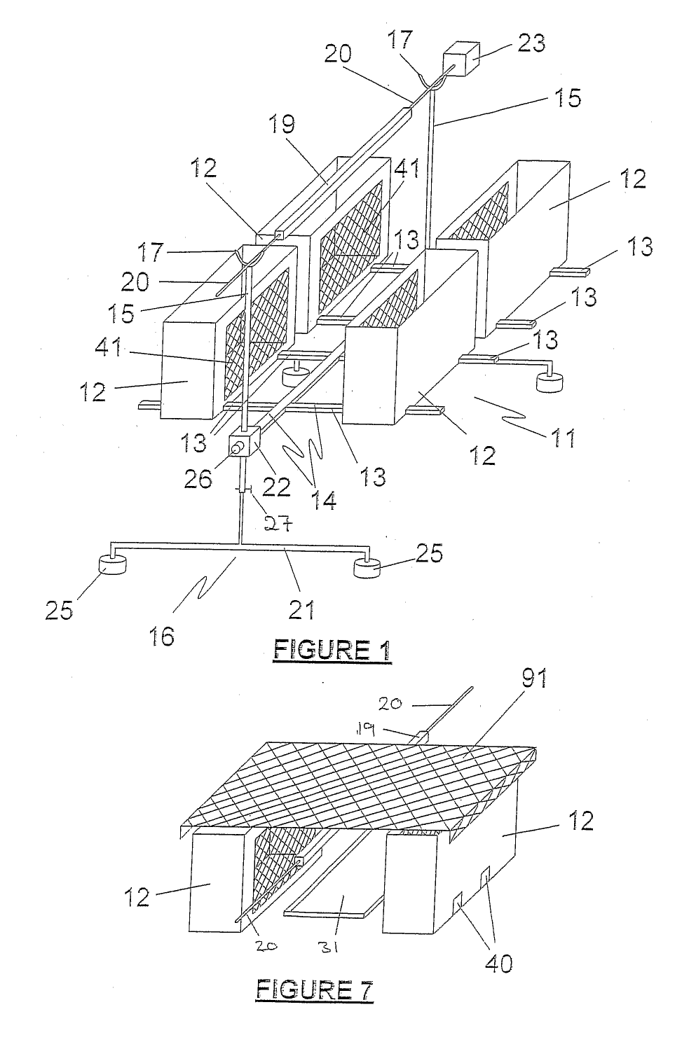

FIG. 1 of the drawings shows a schematic perspective view of a device suitable for roasting meat embodying the invention as generally indicated by 11, the device also includes a tray, but for the sake of clarity, this tray is not shown on FIG. 1, but is shown on the later figures where relevant. The device 11 comprises four heater units 12 which are slidably mounted on the arms 13 of a heater element supporting frame generally indicated by 14. The heater unit supporting frame 14 is adjustably attached at two points to two vertical uprights 15 of the spit support means generally indicated by 16.

The spit support means 16 support a spit by means of two semi circular sections 17.

The spit as generally indicated by 18 comprises a central section 19 which is square shaped when viewed in cross-section and two rod-like end sections 20 which rest on the semi circular shaped sections of the spit support 17.

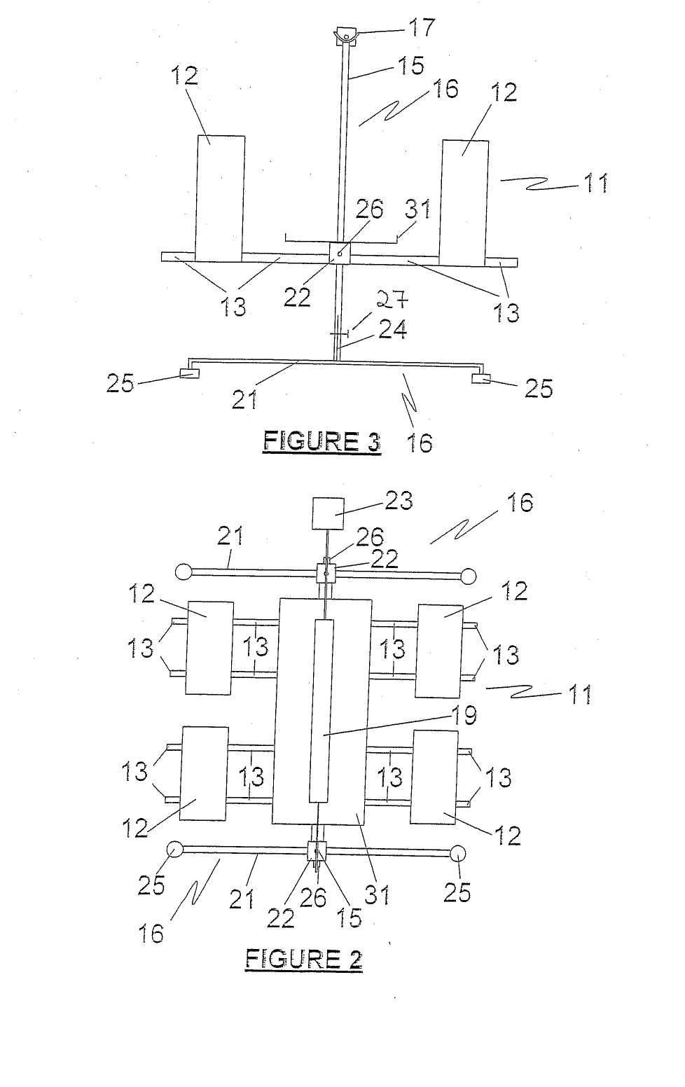

The spit support means 16 comprises, in use, two inverted I shaped frames, the lower cross piece 21 of which have height adjustment means attached at their ends 25. One end of the spit 18 incorporates means not shown to allow connection of the spit 18 to an electric motor 23 suitable for rotating the spit in use. The device 11 further comprises a metallic tray 31 as shown in FIG. 2.

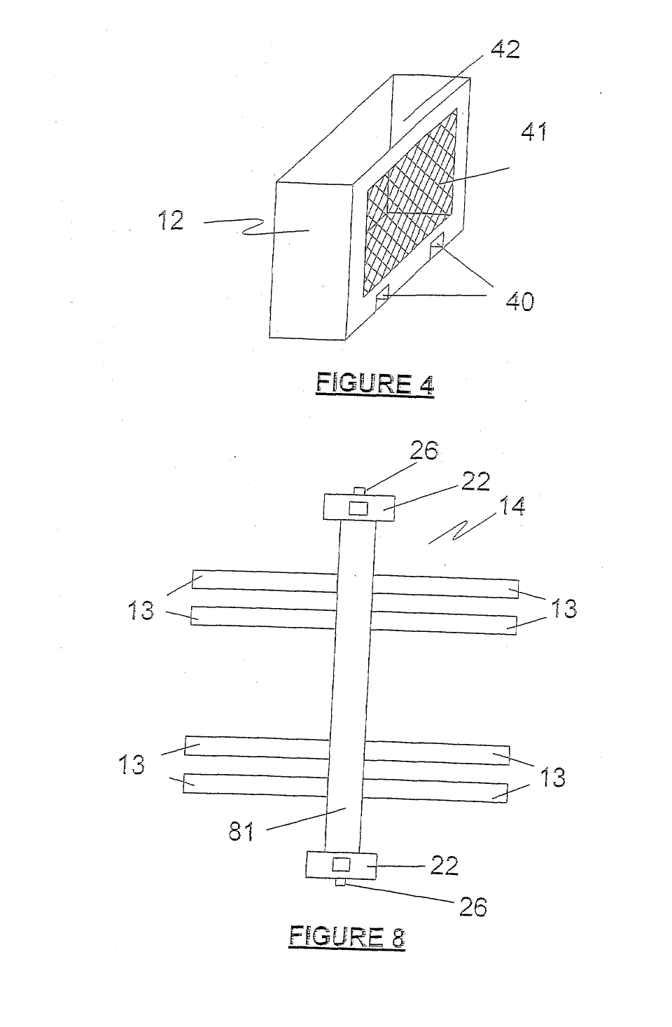

The heater units 12 are slidably mounted on the arms 13 of the heater element support frame 14 by means of passageways 40 incorporated into the units 12, as shown in FIG. 4. The heater units are manufactured from heat resistant metal such as steel and are designed to contain burning charcoal. The faces of the Units directed towards the spit are formed from metal grates 41 and the top faces 42 of the units 12 are open. The heater units 12, in use, are located on either side of the longitudinal axis of the spit 18, as can be seen by reference to FIG. 1, FIG. 2 and FIG. 3.

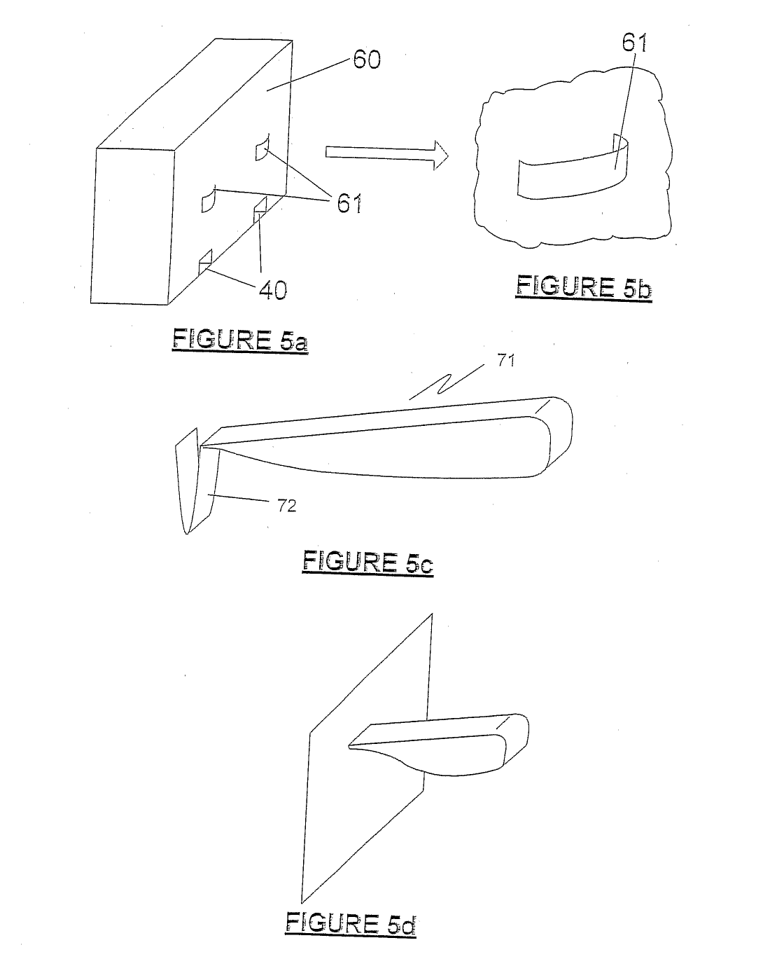

The faces 60 of the heater units 12, on the side opposite the grates 41, incorporate attachment points 61 as shown in FIG. 5a. FIG. 5b shows an expanded view of such an attachment point 61. The attachment points 61 are shaped such that they co-operate with the complementary shaped engaging section 72 of a handle generally indicated by 71 as shown in FIG. 5c. The use of a pair of handles inserted into the attachment points 61 allows the individual heater units to be moved along the arms 13 of the heater element supporting frame 14. The handle 71 may be supplied with a heat deflecting means 73 such as shown in FIG. 5d, in order to protect the hands of a user adjusting the position of the heater Units 12 from heat emitted from the face 60 of the Units.

The heater unit support frame as generally indicated by 14 on FIG. 8 comprises a central member 81 to which are attached a series of arms of 13, which are spaced such as to engage with the passageways 40 of the heater units. Height adjustment means 22 are attached to either end of the central member 81, the height adjustment means 22 engage with the vertical uprights 15 of the spit support means 16 and are of known kind: The position of the height adjustment means 22 relative to the vertical uprights 15 is altered by use of a rotatable knob 26. Rotation of the knob 26 allows adjustment of the position of the heater unit support frame 14 and attached heater units 12 as a single unit by moving said unit up or down the vertical uprights 15.

The spit support means 16 are comprised of two main sections, the vertical uprights 15 are attached to the cross pieces 21 as can be seen on FIG. 3. The cross piece 21 includes a vertical section 24. The vertical uprights 15 are hollow and sized such that they co-operate with the vertical section 24 of the cross pieces 21 and known locking means are provided such that the positions of each of the vertical uprights 15 can be fixed relative to the vertical section of the cross piece 21.

The metallic tray 31, shown on FIGS. 2 and 3, is attached to the central member 81 of the heater unit support frame by the use of known means such that the tray can be readily detached and re-attached to the device for the purpose of cleaning.

Chains, not shown, are attached between the central member 81 of the heater unit support frame 14 and the individual heater units 12, such that the heater units 12 cannot be inadvertently pulled off the arms of the heater unit support frame 14.

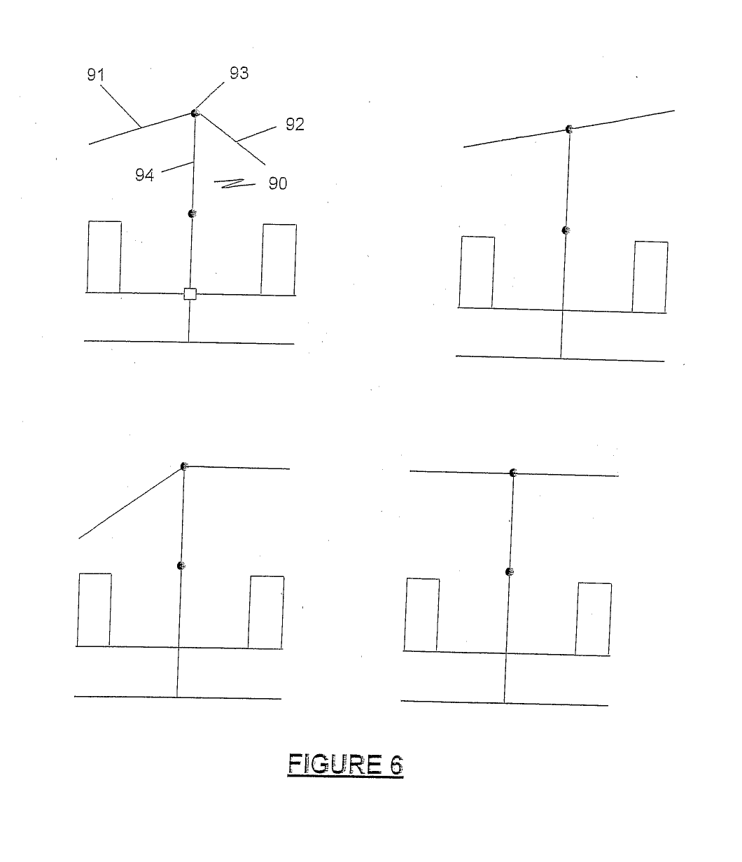

The tray 31 incorporates a drain and plug which are not shown. The device is also supplied with a canopy as shown in FIG. 6. The canopy as generally indicated by 90 incorporates two panels 91 and 92 which are independently adjustable about a central point 93, such that the canopy can be adjusted as required in use. The canopy 90 is produced from suitable heat resistant material such as steel. The panels are of an appropriate length and width in order to protect the heater units and any cooking meat from rainfall during use. The canopy is rigidly attached to a pole 94 which is attached to the vertical uprights 15 of the device by known means.

In use charcoal is placed in the heater units 12 and set alight to provide heat for cooking purposes. The level of heating thus supplied can be varied in a number of ways:
a) The heater units can be moved closer or further away from the meat/spit, as a single unit by the use of the knob 26,
b) The individual heater units 12 can be advanced towards or away from the meat/spit by movement of the units 12 along the arms 13;
c) The level of charcoal contained in the individual units can be varied. For instance, when cooking a pig, the level of the charcoal in the units can be progressively increased along the longitudinal axis of the heater units which run parallel to the longitudinal axis of the spit 18. In this way, the level of heating can be increased from the head of a pig to the rear end of the pig and so uniform cooking times for the meat on the pig are obtained. Even though more meat is present towards the rear of the pig as compared to the body section of the pig adjacent the pig's head.

The fat and juices produced by the meat during the cooking process drop from the meat onto the tray 31 and can be transferred from the tray 31 to a suitable container by means of the plug and drain, such that they can be used to baste the cooking meat if so desired.

The device described herein can also be used to cook smaller pieces of meat, a suitably sized wire mesh 91, see FIG. 7, can be placed across the top of a pair of heater units and food then cooked on the mesh 91. The level of heat supplied by the heater units 12 can be adjusted by altering the distance between parallel units 12. If only two of the four heater units shown on FIGS. 1 to 3 are used then it will still be possible to simultaneously cook smaller pieces of meat placed in the appropriate position on the spit 18.

If required, the tray 31 can be detached from the central member 81 so that the heater units can be positioned closer to each other than would otherwise be possible. The tray may be located on the ground, positioned such that it still, collects juices and fat produced by meat being cooked by the device.

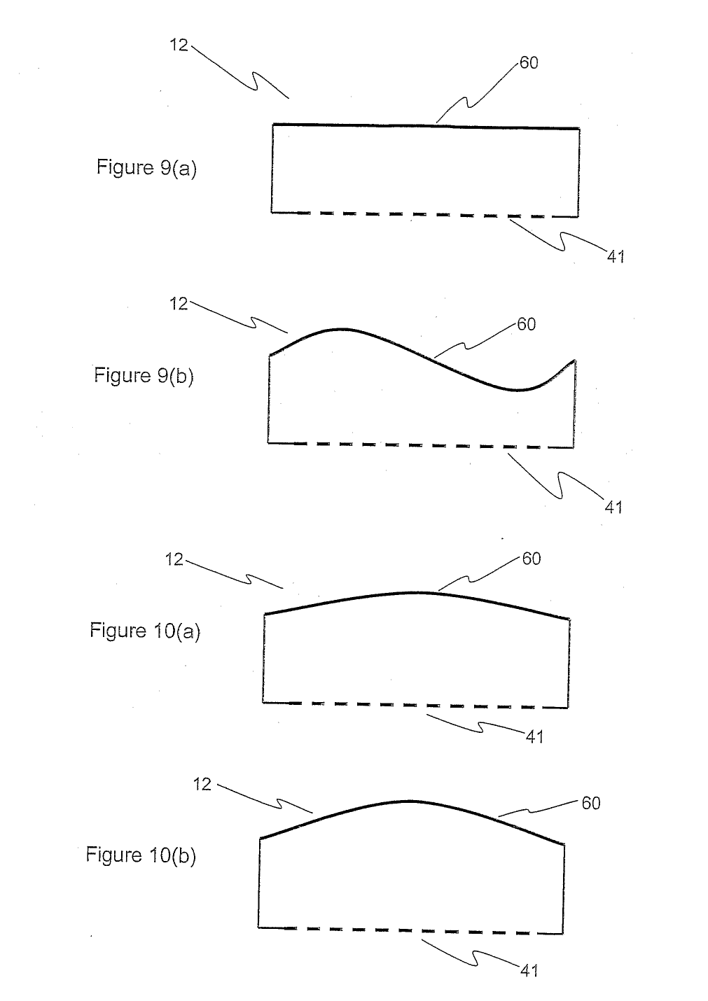

A particularly preferred embodiment wilt now be described with reference to FIGS. 9 and 10. FIG. 9 shows a horizontal cross-section through a heater unit 12 showing the grate, 41, and the opposite face 60. This type of arrangement is used particularly when the heat source is charcoal, contained within the heater unit 12. FIG. 9(a) shows a typical arrangement when the external face 60 of the heater unit 12 is flat, and before heating. When heated, the metal of the unit expands, and the external face 60 can buckle. This is illustrated schematically in FIG. 9(b), where the buckling is exaggerated for clarity. This buckling often occurs suddenly, to relieve the buckling forces generated during heating. The sudden resultant change of shape of the heater unit can cause pieces of charcoal or embers to be ejected from the heater unit 12, and can result in ash or embers contaminating the food, or can pose a hazard for bystanders.

FIG. 10 (a) shows a preferred embodiment of the heater box, where the external face is of a curved or convex construction, when cold. In this particular embodiment, there is a single axis of curvature (vertically down the box, at right angles to the illustrated cross-section), although other geometries are also envisaged, including multi-axis curvature, creating a domed-shape. FIG. 10(b) illustrates the change in shape of the outer face 60, after heating. The initial curvature in the outer face 60 prevents the rapid buckling of the face, thus eliminating the disadvantages described above.

It will be appreciated by those skilled in the art can be made to the invention described herein without departing from the scope thereof.

For instance, the device shown comprises four heater units, two placed on each side of the spit. Alternatively, a series of smaller units could be provided on each side to increase the control of the heat supplied to meat on the spit.

The embodiment previously described utilizes charcoal burning units which could be replaced with gas powered heating units.

Means could be provided such that the heater units could be advanced or retracted relative to the spit by the use of a mechanism operated by a knob or crank handle either individual or as a group.

1-10. (canceled)

11. A roasting device suitable for roasting meat comprising:
a rotatable spit on which, in use, the meat is located;
said spit having opposite sides and a longitudinal axis; and
at least two heating units located respectively on said opposite sides of the spit adjacent said longitudinal axis; said heating units supplying the primary heating effect of said device.

12. A device according to claim 11, wherein said heating units incorporate adjustment means for independently adjusting the proximity of each of the units relative to the position of the spit.

13. A device according to claim 11, further comprising detachable handles which can be attached and detached to said heating units on the side of the units facing away from the spit; wherein said handles incorporate heat deflection means.

14. A device according to claim 11, further comprising adjustment means for allowing the position of all the heating units to be simultaneously adjusted.

15. A device according to claim 11, wherein heater units are charcoal burning units and the device further comprises means for varying the height of the charcoal contained within the units along said axis of the units parallel to said longitudinal axis of said spit.

16. A device according to claim 11, further comprising a shelter for protecting, in use, the roasting meat from rain.

17. A device according to claim 11, further comprising a rack extending between the heating units, on which, in use, food can be cooked.

18. A device according to claim 11, wherein at least one heater unit has an external face which is curved, preferably convex—e.g. domed-form.
